(19) United States
(12) Patent Application Publication
(10) Pub. No.: US 2025/0289283 A1
(43) Pub. Date: Sep. 18, 2025

(54) VALVE ASSEMBLY AND VEHICLE HEAT PUMP SYSTEM INCLUDING THE SAME

(71) Applicant: Hanon Systems, Daejeon (KR)

(72) Inventors: Beom Seok JOO, Daejeon (KR); Kyung Tae NOH, Daejeon (KR); Yun Jin KIM, Daejeon (KR)

(73) Assignee: Hanon Systems, Daejeon (KR)

(21) Appl. No.: 19/072,879

(22) Filed: Mar. 6, 2025

(30) Foreign Application Priority Data
Mar. 15, 2024 (KR) 10-2024-0036343
May 9, 2024 (KR) 10-2024-0061295

(51) Int. Cl. B60H 1/00; F16K 27/00; F25B 30/02; F25B 41/31

(52) U.S. Cl. CPC B60H 1/00485; F16K 27/003; F25B 30/02; F25B 41/31

(57) ABSTRACT

A valve assembly according to one embodiment of the present invention is a valve assembly disposed on a line of a vehicle heat pump system in which a refrigerant flows, the valve assembly may include a first valve module including a first valve housing in which a low-pressure refrigerant flows in a cooling mode and a plurality of expansion valves for expanding the refrigerant according to an air conditioning mode are disposed, and a second valve module including a second valve housing in which a high-pressure refrigerant flows in the cooling mode and a plurality of opening and closing valves which control a flow of the refrigerant are disposed.

### CROSS-REFERENCE TO RELATED APPLICATION

This application claims priority to and the benefit of Korean Patent Application No. 10-2024-0036343, filed on Mar. 15, 2024 and Korean Patent Application No. 10-2024-0061295, filed on May 9, 2024, the disclosure of each is incorporated herein by reference in their entirety.

### BACKGROUND

### 1. Field of the Invention

The present invention relates to a valve assembly, and more specifically, to a vehicle heat pump system in which a valve assembly is disposed on a refrigerant circulation line.

### 2. Discussion of Related Art

Under the trend of development of eco-friendly industries and development of energy sources that replace fossil fuels, the most attractive fields in the automobile industry in recent years are electric and hybrid vehicle fields. Batteries are mounted in electric and hybrid vehicles, provide driving power to the electric and hybrid vehicles, and are used not only for driving but also for heating and cooling.

In vehicles in which driving power is provided using batteries, the use of batteries as a heat source during cooling or heating means that a driving distance thereof is reduced as much as the use amount, and a method of applying a heat pump system that is conventionally widely used as a home cooling and heating system to vehicles has been proposed to overcome the above problem.

As a reference, a heat pump absorbs low-temperature heat and changes the absorbed heat to high-temperature heat. As one embodiment, the heat pump has a cycle in which a liquid refrigerant becomes gas by evaporating in an evaporator and absorbing heat from surroundings and then is liquefied while emitting heat from a condenser to the surroundings. When the heat pump is applied to an electric vehicle or hybrid vehicle, there is an advantage of securing a heat source that is insufficient in a conventional general air conditioner case.

Currently, a modularized configuration of a heat pump system for an electric vehicle is implemented as a partial modulization method, and main components (a valve, an accumulator, a chiller, a condenser, an inner heat exchanger, a sensor, etc.) thereof are connected through pipes, fittings and connectors should be additionally provided for connecting the pipes, and proper tolerances for connecting the components are present. Therefore, there are disadvantages in packaging, costs, workability, etc.

A technology for modularizing a manifold is developed to resolve such disadvantages, and there is a problem that performance is degraded due to thermal interference between a high-temperature refrigerant and a low-temperature refrigerant during a modulization process.

In addition, in the conventional heat pump system, since an expansion valve located in the front of an indoor heat exchanger is disposed separately from a refrigerant module, there is a problem that thermal loss is reduced due to a pressure-drop of a refrigerant after expansion thereof.

### SUMMARY OF THE INVENTION

One embodiment of the present invention is directed to providing a valve assembly, in which a first valve module in which a low-pressure refrigerant flows and a second valve module in which a high-pressure refrigerant flows are separately provided to minimize thermal interference between the refrigerants flowing in the first valve module and the second valve module, and a vehicle heat pump system including the same.

In addition, one embodiment of the present invention is directed to providing a valve assembly, in which a refrigerant flowing into a first valve housing is expanded in an expansion valve and then immediately discharged from the first valve housing to minimize thermal interference between refrigerants, and a vehicle heat pump system including the same.

In addition, one embodiment of the present invention is provided to providing a vehicle heat pump system in which a second expansion valve and an indoor heat exchanger are directly or closely connected to maximally reduce a refrigerant path along which a refrigerant expanded by the second expansion valve flows toward the indoor heat exchanger and minimize thermal loss and pressure-drop.

Objects to be solved by the present invention are not limited to the above-described objects, and other objects which are not described above will be clearly understood by those skilled in the art through the following description.

One aspect of the present invention provides a valve assembly disposed on a line of a vehicle heat pump system in which a refrigerant flows, the valve assembly including a first valve module including a first valve housing in which a low-pressure refrigerant flows in a cooling mode and a plurality of expansion valves for expanding the refrigerant according to an air conditioning mode are disposed, and a second valve module including a second valve housing in which a high-pressure refrigerant flows in the cooling mode and a plurality of opening and closing valves which control a flow of the refrigerant are disposed.

The refrigerant expanded in the expansion valves may be discharged to the outside through the first valve housing.

A first recessed portion may be formed in the first valve housing at a corresponding location between the expansion valve and the opening and closing valve.

A second recessed portion may be formed in the second valve housing at a corresponding location between the opening and closing valves.

The first recessed portions and the second recessed portions may be formed to have groove shapes in the first valve housing and the second valve housing.

The expansion valves may include a first expansion valve which expands a refrigerant discharged from an indoor condenser in a heating mode, a second expansion valve which expands a refrigerant flowing into an indoor heat exchanger, and a third expansion valve which expands a refrigerant flowing into a chiller.

The opening and closing valves disposed in the first valve housing may include a first opening and closing valve which is disposed between an outdoor heat exchanger and a compressor and controls a flow of a refrigerant, a second opening and closing valve which is disposed between an indoor heat exchanger and the compressor and controls a flow of a refrigerant, and a third opening and closing valve which is disposed between an indoor condenser and a water-cooled condenser and controls a flow of a refrigerant.

The opening and closing valves disposed in the second valve housing may include a fourth opening and closing valve which is disposed between a compressor and a water-cooled condenser and controls a flow of a refrigerant, a fifth opening and closing valve which is disposed between an indoor heat exchanger and the water-cooled condenser and controls a flow of a refrigerant, and a sixth opening and closing valve which is disposed between an outdoor heat exchanger and the indoor heat exchanger and controls a flow of a refrigerant.

Another aspect of the present invention provides a vehicle heat pump system including a refrigerant circulation line which circulates a compressor, a water-cooled condenser, an outdoor heat exchanger, and an indoor heat exchanger and exchanges heat between a refrigerant circulating the indoor heat exchanger and air discharged to indoors, wherein a plurality of expansion valves which expand the refrigerant according to an air conditioning mode and a plurality of opening and closing valves which control a flow of the refrigerant are disposed on the refrigerant circulation line, and the expansion valves are disposed in a first valve module in which a low-pressure refrigerant flows in a cooling mode.

The first valve module may include a first valve housing coupled to the expansion valves, and the vehicle heat pump system may include a second valve module including a second valve housing in which a high-pressure refrigerant flows in the cooling mode and a plurality of opening and closing valves for controlling a flow of the refrigerant are disposed.

The refrigerant expanded in the expansion valves may be discharged to the outside through the first valve housing, and the plurality of opening and closing valves which control the flow of the refrigerant may be disposed in the first valve housing.

A first recessed portion may be formed in the first valve housing at a corresponding location between the expansion valve and the opening and closing valve, and a second recessed portion may be formed in the second valve housing at a corresponding location between the opening and closing valves.

The opening and closing valves disposed in the first valve housing may include a first opening and closing valve which is disposed between the outdoor heat exchanger and the compressor and controls a flow of a refrigerant, a second opening and closing valve which is disposed between the indoor heat exchanger and the compressor and controls a flow of a refrigerant, and a third opening and closing valve which is disposed between an indoor condenser and the water-cooled condenser and controls a flow of a refrigerant.

The opening and closing valves disposed in the second valve housing may include a fourth opening and closing valve which is disposed between the compressor and the water-cooled condenser and controls a flow of a refrigerant, a fifth opening and closing valve which is disposed between the indoor heat exchanger and the water-cooled condenser and controls a flow of a refrigerant, and a sixth opening and closing valve which is disposed between the outdoor heat exchanger and the indoor heat exchanger and controls a flow of a refrigerant.

Still another aspect of the present invention provides a vehicle heat pump system including a refrigerant circulation line which circulates a compressor and a plurality of heat exchangers including an indoor heat exchanger disposed in an air conditioning case and exchanges heat between a refrigerant circulating the indoor heat exchanger and air discharged to indoors, wherein a valve assembly including a plurality of expansion valves which expand the refrigerant according to an air conditioning mode and a plurality of opening and closing valves which control a flow of the refrigerant are disposed on the refrigerant circulation line, the valve assembly includes a second expansion valve which expands the refrigerant flowing into the indoor heat exchanger, and the valve assembly is connected to an inlet pipe and an outlet pipe of the indoor heat exchanger.

The valve assembly may be divided into a flow path of the refrigerant flowing into the inlet pipe and a flow path of the refrigerant flowing from the outlet pipe.

The inlet pipe and the outlet pipe may be directly connected to a side surface of the valve assembly.

An inlet pipe flange and an outlet pipe flange may be provided on an end portion of the inlet pipe and an end portion of the outlet pipe, and the inlet pipe flange and the outlet pipe flange may be directly connected to a side surface of the valve assembly.

Connecting pipes through which the refrigerant expanded in the second expansion valve is discharged may be connected to a side surface of the valve assembly, and the connecting pipes may be connected to the inlet pipe and the outlet pipe.

One end portion of each of the connecting pipes may be coupled to the side surface of the valve assembly, the connecting pipes may expand linearly, and the other end portion of each of the connecting pipes may be coupled to the inlet pipe and the outlet pipe.

The inlet pipe and the outlet pipe may pass through the air conditioning case and may be connected to an external part, and the valve assembly may be disposed to face one side surface of the air conditioning case through which the inlet pipe and the outlet pipe pass to an outside.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a perspective view illustrating a first valve module of a valve assembly according to one embodiment of the present invention;

FIG. 2 is a perspective view illustrating a second valve module of the valve assembly according to one embodiment of the present invention;

FIG. 3 is a view illustrating a vehicle heat pump system according to one embodiment of the present invention;

FIG. 4 is a view illustrating one example of a connecting structure of the valve assembly and an indoor heat exchanger in the vehicle heat pump system according to one embodiment of the present invention;

FIG. 5 is a view illustrating a flow of a refrigerant in the embodiment illustrated in FIG. 4;

FIG. 6 is a view illustrating a flow of the refrigerant passing through in a second expansion valve in the first valve module;

FIG. 7 is a view illustrating another example of the connecting structure of the valve assembly and the indoor heat exchanger in the vehicle heat pump system according to one embodiment of the present invention;

FIG. 8 is a view illustrating a flow of a refrigerant of the embodiment illustrated in FIG. 7;

FIG. 9 is a view illustrating is a flow of the refrigerant in a cooling mode in the vehicle heat pump system according to one embodiment of the present invention;

FIG. 10 is a perspective view schematically illustrating a flow of the refrigerant in a cooling mode in the valve assembly according to one embodiment of the present invention;

FIG. 11 is a view illustrating a flow of the refrigerant in the cooling mode when cooling a battery in the vehicle heat pump system according to one embodiment of the present invention;

FIG. 12 is a view illustrating a flow of the refrigerant in a heating mode in the vehicle heat pump system according to one embodiment of the present invention;

FIG. 13 is a perspective view schematically illustrating a flow of the refrigerant in a heating mode in the valve assembly according to one embodiment of the present invention;

FIG. 14 is a view illustrating a flow of the refrigerant in a defrosting mode in the vehicle heat pump system according to one embodiment of the present invention; and

FIG. 15 is a view illustrating a flow of the refrigerant in a dehumidification/constant-temperature mode in the vehicle heat pump system according to one embodiment of the present invention.

### DETAILED DESCRIPTION OF EXEMPLARY EMBODIMENTS

Since the present invention may be variously modified and have several embodiments, specific embodiments will be illustrated in the accompanying drawings and described in detail. However, this is not intended to limit the present invention to the specific embodiments, and it should be appreciated that all changes, equivalents, and substitutes falling within the spirit and technical scope of the present invention are encompassed in the present invention. In the description of the embodiments, certain detailed descriptions of the related art will be omitted when it is deemed that they may unnecessarily obscure the gist of the inventive concept.

Terms such as “first” and “second” may be used to describe various components, but the components are not limited by the above terms. These terms are used only to distinguish one component from another.

Terms used herein are only for the purpose of describing particular embodiments and are not intended to limit the present invention. Singular forms are intended to include the plural forms, unless the context clearly indicates otherwise. In the present specification, it should be understood that terms such as “comprise” and “include” herein specify the presence of stated features, numbers, steps, operations, elements, components, or combinations thereof but do not preclude the presence or addition of one or more other features, numbers, steps, operations, elements, components, or combinations thereof.

In addition, throughout the specification, when components are “connected,” this may not only mean that two or more components are directly connected, but this may also mean that two or more components are indirectly connected through other components or are physically connected and also electrically connected, or are one component even when referred to as different names according to positions or functions thereof.

Hereinafter, one embodiment of a manifold coolant module will be described in detail with reference to the accompanying drawings, and when the embodiment is described with reference to the accompanying drawings, components which are the same or correspond to each other will be denoted by the same reference numerals, and redundant description thereof will be omitted.

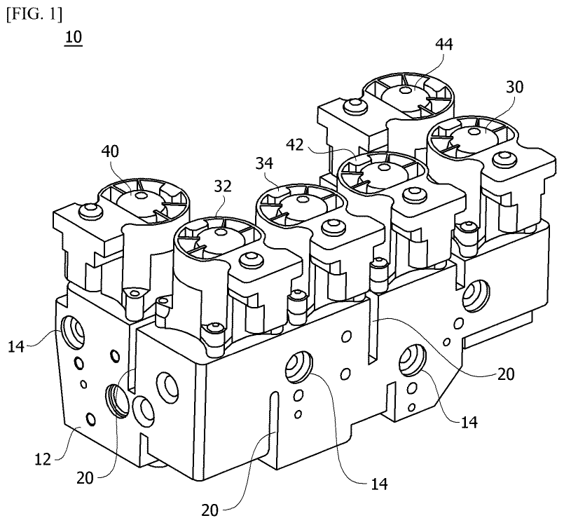

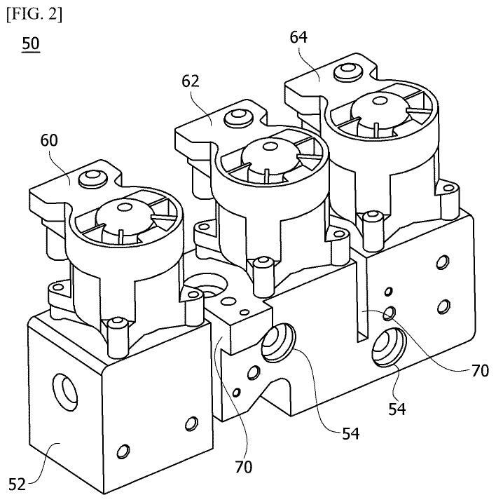

FIG. 1 is a perspective view illustrating a first valve module of a valve assembly according to one embodiment of the present invention, and FIG. 2 is a perspective view illustrating a second valve module of the valve assembly according to one embodiment of the present invention.

According to the drawings, the valve assembly according to one embodiment of the present invention may be a valve assembly disposed on a line of a vehicle heat pump system in which a refrigerant flows and may include a first valve module 10 including a first valve housing 12 in which a low-pressure refrigerant flows in a cooling mode and a plurality of expansion valves 30, 32, and 34 for expanding the refrigerant according to an air conditioning mode are disposed and a second valve module 50 including a second valve housing 52 in which a high-pressure refrigerant flows in the cooling mode and a plurality of opening and closing valves 60, 62, and 64 for controlling a flow of the refrigerant are disposed.

The first valve module 10 may include the first valve housing 12 in which the refrigerant flows and to which the expansion valves and opening and closing valves are each coupled. The expansion valves serve to control expansion of the refrigerant flowing into the first valve housing 12, and the opening and closing valves serves to control a flow of the refrigerant flowing into the first valve housing 12.

The first valve housing 12 may be formed as a structure having a block shape, and the expansion valves and the opening and closing valves may be coupled to one surface of the first valve housing 12. In addition, first gates 14 through which the refrigerant is introduced or discharged may be formed in the other surface to which the expansion valves and the opening and closing valves are not coupled. That is, although not specifically illustrated in the drawings, a flow path for the flow of the refrigerant is formed as an optimum line in the first valve housing 12, and the first gates 14 through which the refrigerant is introduced or discharged to the flow path of the first valve housing 12 may be formed at various locations. The first gates 14 illustrated in FIGS. 1 and 2 are only proposed as one embodiment and may be formed in various shapes at other locations according to locations at which the expansion valves and the opening and closing valves are arranged.

Three expansion valves may be disposed in the first valve module 10. This is only proposed as one embodiment, and two or less or four or more expansion valves may be disposed in the first valve module 10. In the present embodiment, after the refrigerant flowing into the expansion valve expands, the refrigerant may be discharged to the outside through the flow path of the first valve housing 12. More specifically, it should be designed that the refrigerant is immediately discharged after the refrigerant expanded in the expansion valve flows an optimum or shortest distance in the flow path of the first valve housing 12. This is to minimize thermal interference after the refrigerant expands and enters a low-temperature and low-pressure state.

The expansion valves disposed in the first valve housing 12 may include a first expansion valve 30 which expands the refrigerant discharged from an indoor condenser 142 in a heating mode, a second expansion valve 32 which expands the refrigerant flowing into an indoor heat exchanger 144, and a third expansion valve 34 which expands the refrigerant flowing into a chiller 150. In the present embodiment, the first expansion valve 30, the second expansion valve 32, and the third expansion valve 34 are disclosed as the expansion valves, but the present invention is not limited thereto, and only some of the expansion valves may be disposed. Functions of the expansion valves will be described more specifically when the vehicle heat pump system is described below.

In addition, a plurality of opening and closing valves may be disposed in the first valve housing 12. As one embodiment, the opening and closing valves may include a first opening and closing valve 40 which controls a flow of the refrigerant discharged from an outdoor heat exchanger 130, a second opening and closing valve 42 which controls a flow of the refrigerant discharged from the indoor heat exchanger 144, and a third opening and closing valve 44 which controls a flow of the refrigerant discharged from the indoor condenser 142. In the present embodiment, the first opening and closing valve 40, the second opening and closing valve 42, and the third opening and closing valve 44 are disclosed as the opening and closing valve, but are only one example, and the opening and closing valves for controlling the refrigerant may include two or less or four or more opening and closing valves.

The expansion valves 30, 32, and 34 and the opening and closing valves 40, 42, and 44 disposed in the first valve module 10 are provided as valves in which the low-pressure refrigerant flows in the cooling mode. This is to allow the refrigerant, which flows in the first valve module 10, to flow as the low-pressure and low-temperature refrigerant in the cooling mode, and to allow the refrigerant, which flows in the second valve module 50 which will be described below, to flow as the high-pressure and high-temperature refrigerant in the cooling mode. As the first valve module 10 in which the low-pressure refrigerant flows and the second valve module 50 in which the high-pressure refrigerant flows are separately provided, thermal interference between the refrigerants flowing in the first valve module 10 and the second valve module 50 may be minimized.

In the first valve housing 12, first recessed portions 20 may be formed at corresponding locations between the expansion valves 30, 32, and 34 and the opening and closing valves 40, 42, and 44. The first recessed portions 20 are portions formed to minimize occurrence of thermal interference between the refrigerant flowing in the expansion valves 30, 32, and 34 and the opening and closing valves 40, 42, and 44 and the refrigerant flowing in the expansion valves 30, 32, and 34 and the opening and closing valves 40, 42, and 44 adjacent thereto.

As one embodiment, the first recessed portions 20 may be formed to have groove shapes between the expansion valves 30, 32, and 34 and the opening and closing valves 40, 42, and 44 in the first valve housing 12 as described in the drawings. This is only proposed as one embodiment, and any portion capable of minimizing thermal interference in the adjacent flow paths may be applied as the first recessed portions 20.

The second valve housing 52 may be formed as a structure having a block shape like the first valve housing 12, and the opening and closing valves may be coupled to one surface of the second valve housing 52. In addition, second gates 54 through which the refrigerant flows into and out may be formed in the other surface to which the opening and closing valves are not coupled. That is, although not specifically illustrated in the drawings, a flow path for a flow of the refrigerant is formed as an optimum line in the second valve housing 52, and the second gates 54 through which the refrigerant is introduced or discharged to the flow path of the second valve housing 52 may be formed at various locations. The second gates 54 illustrated in FIGS. 1 and 2 are only proposed as one embodiment and may be formed in various shapes at other locations according to locations at which the opening and closing valves are arranged.

A difference of the second valve housing 52 from the first valve housing 12 is that only the opening and closing valves are disposed in the second valve housing 52 without arranging expansion valves therein. In the present embodiment, since the second valve module 50 is configured to allow the high-pressure refrigerant to mainly flow, only the opening and closing valves rather than the expansion valves may be disposed.

As one embodiment, the opening and closing valves may include a fourth opening and closing valve 60 which controls a flow of the refrigerant discharged from a compressor 110, a fifth opening and closing valve 62 which controls a flow of the refrigerant flowing into a water-cooled condenser 120, and a sixth opening and closing valve 64 which controls a flow of the refrigerant flowing into the outdoor heat exchanger 130. In the present embodiment, the fourth opening and closing valve 60, the fifth opening and closing valve 62, and the sixth opening and closing valve 64 are disclosed as the opening and closing valves, but are not limited thereto, and this is proposed as only one example, and the opening and closing valves for controlling the refrigerant may include two or more or four or more opening and closing valves.

The refrigerant flowing in the second valve module 50 may have a high-pressure in the cooling mode, and maintain a low-pressure in the heating mode like the refrigerant flowing in the first valve module 10.

In the second valve housing 52, second recessed portions 70 may be formed at corresponding locations between the opening and closing valves 60, 62, and 64. The second recessed portions 70 are potions for minimizing occurrence of thermal interference between the refrigerant flowing in the opening and closing valves 60, 62, and 64 and the refrigerant flowing in the opening and closing valves 60, 62, and 64 adjacent thereto.

As one embodiment, the recessed portions 70 may be formed to have groove shapes between the opening and closing valves 60, 62, and 64 in the second valve housing 52 as described in the drawings. This is only proposed as one embodiment, any portion capable of minimizing thermal interference in the adjacent flow paths may be applied as the second recessed portions 70.

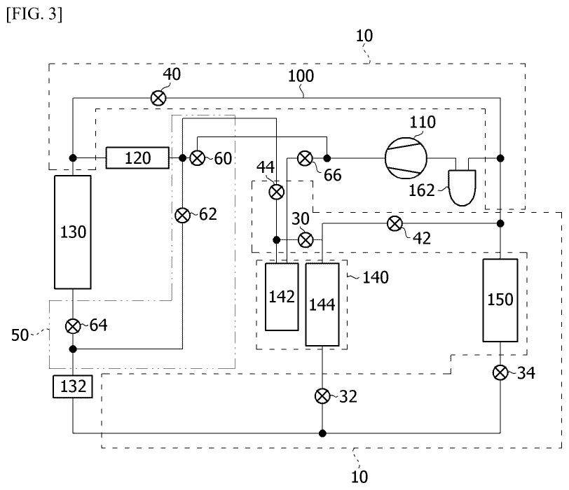

FIG. 3 is a view illustrating the vehicle heat pump system according to one embodiment of the present invention.

Referring to the drawing, in the vehicle heat pump system according to one embodiment of the present invention including a refrigerant circulation line 100 which circulates the compressor 110, the water-cooled condenser 120, the outdoor heat exchanger 130, and the indoor heat exchanger 144 and in which a refrigerant circulating the indoor heat exchanger 144 exchanges heat with air discharged to indoors, the plurality of expansion valves for expanding the refrigerant and the plurality of opening and closing valves for controlling the flow of the refrigerant according to an air conditioning mode may be disposed on the refrigerant circulation line 100. In addition, the expansion valves may be disposed in the first valve module 10 in which the low-pressure refrigerant flows in a cooling mode.

In the present drawing, the expansion valves and the opening and closing valves are disposed in the first valve module 10 except portions around the water-cooled condenser 120 and the outdoor heat exchanger 130.

The first expansion valve 30 disposed in the first valve module 10 is to expand the refrigerant discharged from the indoor condenser 142, is disposed between the indoor condenser 142 and the indoor heat exchanger 144, and expands the refrigerant which is discharged from the indoor condenser 142 and flows into the indoor heat exchanger 144. The second expansion valve 32 is disposed between the outdoor heat exchanger 130 and the indoor heat exchanger 144 and expands the refrigerant which is discharged from the outdoor heat exchanger 130 and flows into the indoor heat exchanger 144. The third expansion valve 34 is disposed between the outdoor heat exchanger 130 and the chiller 150 and expands the refrigerant which is discharged from the outdoor heat exchanger 130 and flows into the chiller 150.

In addition, the first opening and closing valve 40 is disposed between the outdoor heat exchanger 130 and the compressor 110 and controls the flow of the refrigerant which is discharged from the outdoor heat exchanger 130 and flows into the compressor 110. The second opening and closing valve 42 is disposed between the indoor heat exchanger 144 and the compressor 110 and controls the flow of the refrigerant which is discharged from the indoor heat exchanger 144 and flows into the compressor 110. The third opening and closing valve 44 is disposed between the indoor condenser 142 and the water-cooled condenser 120 and controls the flow of the refrigerant which is discharged from the indoor condenser 142 and flows into the water-cooled condenser 120.

The opening and closing valves disposed around the water-cooled condenser 120 and the outdoor heat exchanger 130 may be disposed in the second valve module 50. Since the second valve module 50 is disposed in front of the water-cooled condenser 120 and the outdoor heat exchanger 130, a relatively high-temperature and high-pressure refrigerant flows in the second valve module 50, and thus the second valve module 50 is provided separately from the first valve module 10 such that thermal interference does not occur.

The fourth opening and closing valve 60 is disposed between the compressor 110 and the water-cooled condenser 120 and controls the flow of the refrigerant which is discharged from the compressor 110 and flows into the water-cooled condenser 120. The fifth opening and closing valve 62 is disposed between the indoor heat exchanger 144 and the water-cooled condenser 120 and controls the flow of the refrigerant which is discharged from the indoor heat exchanger 144 and flows into the water-cooled condenser 120. The sixth opening and closing valve 64 is disposed between the outdoor heat exchanger 130 and the indoor heat exchanger 144 controls the flow of the refrigerant between the outdoor heat exchanger 130 and the indoor heat exchanger 144.

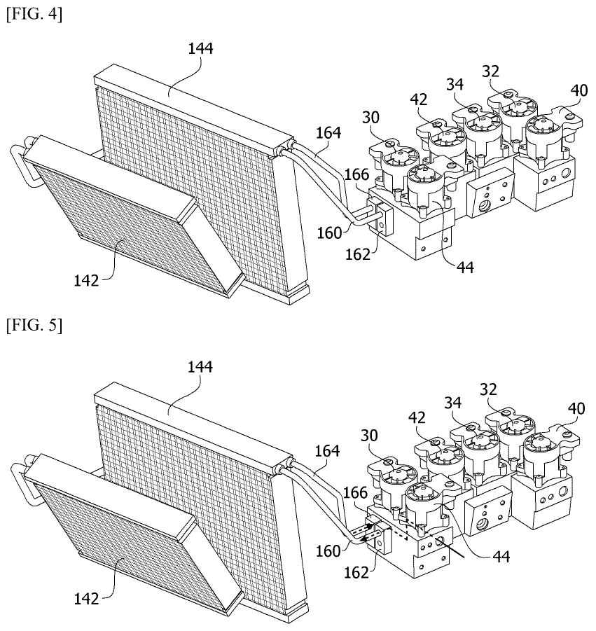

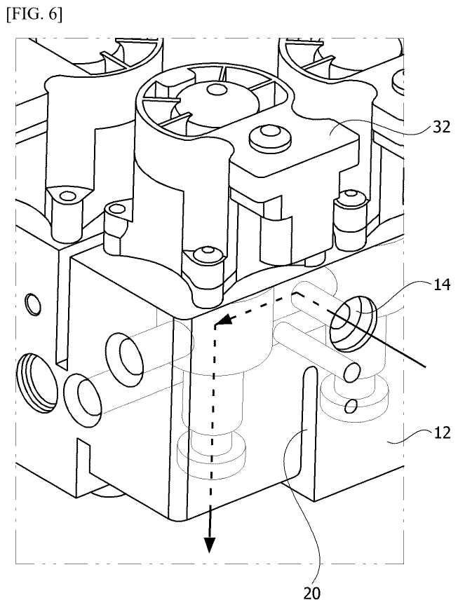

FIG. 4 is a view illustrating one example of a connecting structure of the valve assembly and the indoor heat exchanger in the vehicle heat pump system according to one embodiment of the present invention, FIG. 5 is a view illustrating a flow of a refrigerant in the embodiment illustrated in FIG. 4, and FIG. 6 is a view illustrating a flow of the refrigerant passing through in the second expansion valve in the first valve module.

Referring to FIG. 4, in the vehicle heat pump system according to one embodiment of the present invention including the refrigerant circulation line 100 which circulates the compressor 110, the water-cooled condenser 120, the outdoor heat exchanger 130, and the indoor heat exchanger 144 and in which the refrigerant circulating the indoor heat exchanger 144 exchanges heat with air discharged to indoors, the plurality of expansion valves for expanding the refrigerant and the plurality of opening and closing valves for controlling the flow of the refrigerant according to the air conditioning mode may be disposed on the refrigerant circulation line 100, the valve assembly may include the second expansion valve 32 which expands the refrigerant flowing into the indoor heat exchanger 144, and the valve assembly may be connected to an inlet pipe 160 and an outlet pipe 164 of the indoor heat exchanger 144.

More specifically, the valve assembly may include the first valve module 10 and the second valve module 50 as described above, and among them, the first valve module 10 in which the second expansion valve 32 is disposed may be connected to the inlet pipe 160 and the outlet pipe 164 of the indoor heat exchanger 144. This is because the second expansion valve 32 connected to the indoor heat exchanger 144 and a refrigerant path is disposed in the first valve module 10, but when the second expansion valve 32 is disposed in the second valve module 50, the second valve module 50 may be connected to the inlet pipe 160 and the outlet pipe 164 of the indoor heat exchanger 144.

In the present embodiment, the reason why the second expansion valve 32 is directly connected to the indoor heat exchanger 144 is to maximally reduce the refrigerant path of the refrigerant which is expanded by the second expansion valve 32 and flows toward the indoor heat exchanger 144 so as to minimize thermal loss. That is, a length of the flow path of the refrigerant flowing between the second expansion valve 32 and the indoor heat exchanger 144 may be minimized to minimize pressure-drop thereof.

As one embodiment, in the valve assembly, a flow path of the refrigerant flowing into the inlet pipe 160 of the indoor heat exchanger 144 and a flow path of the refrigerant flowing from the outlet pipe 164 may be divided.

As one embodiment, the inlet pipe 160 and the outlet pipe 164 of the indoor heat exchanger 144 may be directly connected to a side surface of the valve assembly. As described above, the inlet pipe 160 and the outlet pipe 164 are directly connected to the first gates 14 formed in a side surface of the first valve module 10 to minimize thermal loss and pressure-drop of the refrigerant.

As one embodiment, an inlet pipe flange 162 and an outlet pipe flange 166 may be provided on an end portion of the inlet pipe 160 and an end portion of the outlet pipe 164, and the inlet pipe flange 162 and the outlet pipe flange 166 may be directly connected to the side surface of the first valve module 10. That is, the inlet pipe flange 162 and the outlet pipe flange 166 may be provided on the end portion of the inlet pipe 160 and the end portion of the outlet pipe 164 for firm coupling with the first valve module 10, and the inlet pipe flange 162 and the outlet pipe flange 166 may be directly coupled to the side surface of the first valve module 10. However, the present embodiment is only one example proposed for coupling of the inlet pipe 160 and the outlet pipe 164, and the inlet pipe flange 162 and the outlet pipe flange 166 may be directly coupled to the first valve module 10 as described above.

Meanwhile, the inlet pipe 160 and the outlet pipe 164 may extend in the same direction to directly connect the inlet pipe 160 and the outlet pipe 164 to the first valve module 10 easily as described above. The inlet pipe 160 and the outlet pipe 164 extending as described above may be coupled to the side surface of the first valve module 10 disposed to correspond thereto. In other words, the side surface of the first valve module 10 should be disposed to be located at the end portions of the inlet pipe 160 and the outlet pipe 164 for coupling with the first valve module 10 to the inlet pipe 160 and the outlet pipe 164.

In addition, the inlet pipe 160 and the outlet pipe 164 may pass through an air conditioning case 140 and may be connected to an external part, and the valve assembly may be disposed to face one side surface of the air conditioning case 140 through which the inlet pipe 160 and the outlet pipe 164 pass to the outside. Since the inlet pipe 160 and the outlet pipe 164 extend toward a side surface of the indoor heat exchanger 144 disposed in the air conditioning case 140 in a width direction, the inlet pipe 160 and the outlet pipe 164 may pass through one side surface of the air conditioning case 140 and may be connected to an external part. In this case, when the valve assembly is located to face one side surface of the air conditioning case 140 through which the inlet pipe 160 and the outlet pipe 164, a compact space is formed in a vehicle, thereby improving space efficiency.

Meanwhile, among the inlet pipe 160 and the outlet pipe 164, an insulation process may be performed on a portion, which passes through the air conditioning case 140 and is externally exposed, for preventing thermal loss. For example, among the inlet pipe 160 and the outlet pipe 164, an insulation member may be wound around the portion which passes through the air conditioning case 140 and is externally exposed.

Referring to FIG. 5, the refrigerant expanded by the second expansion valve 32 flows into the indoor heat exchanger 144 through the inlet pipe 160 and performs heat exchanging. In addition, the refrigerant discharged after heat exchanging is performed in the indoor heat exchanger 144 may flow into the first valve module 10 through the outlet pipe 164.

In FIG. 6, a flow path of the refrigerant passing through the second expansion valve 32 in the first valve module 10 is illustrated. First, the high-temperature and high-pressure refrigerant may flow through the first gate 14 formed in the first valve module 10. It should be designed that the refrigerant flowing thereinto as described above is discharged immediately after flowing an optimum or shortest distance in the flow path formed in the first valve module 10. This is to minimize thermal interference after the refrigerant expands and then enters a low-temperature and low-pressure state.

Accordingly, as illustrated in FIG. 6, the high-temperature and high-pressure refrigerant may expand in the second expansion valve 32, may become the low-temperature and low-pressure refrigerant, and may be immediately discharged to the inlet pipe 160 through a vertical downward flow path and the first gate 14. That is, the flow path is provided such that the low-temperature and low-pressure refrigerant expanded in the second expansion valve 32 may be immediately discharged to the outside of the first valve module 10 without passing through another flow path in the first valve module 10.

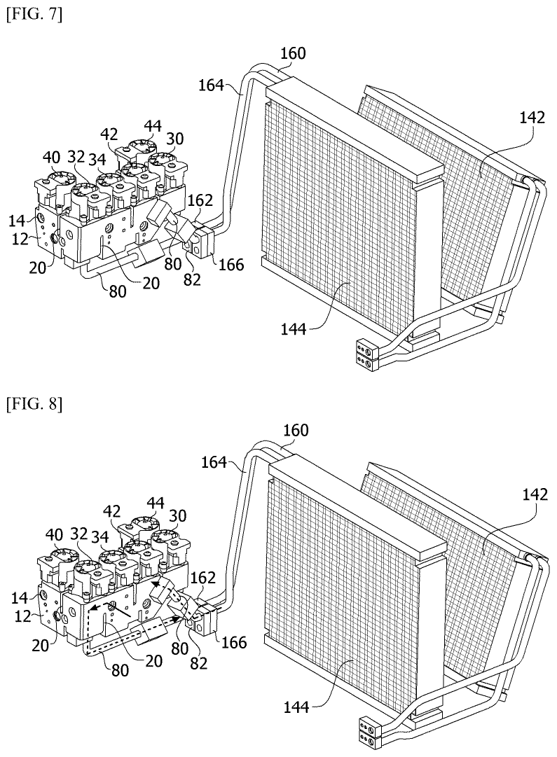

FIG. 7 is a view illustrating another example of the connecting structure of the valve assembly and the indoor heat exchanger in the vehicle heat pump system according to one embodiment of the present invention, and FIG. 8 is a view illustrating a flow of a refrigerant of the embodiment illustrated in FIG. 7.

Referring to FIG. 7, in the present embodiment, the inlet pipe 160 and the outlet pipe 164 may be connected to the first valve module 10 though connecting pipes 80. A pair of connecting pipes 80 may be connected to the inlet pipe 160 and the outlet pipe 164.

It may be difficult to directly connect the inlet pipe 160 and the outlet pipe 164 to the first valve module 10 due to a spatial limitation in a process of arranging the indoor heat exchanger 144 and the first valve module 10 in the vehicle. In this case, it is intended to form a refrigerant path by arranging the first valve module 10 to be close to the indoor heat exchanger 144 and connecting the indoor heat exchanger 144 to the first valve module 10 using the connecting pipes 80.

In this case, it is illustrated in the present drawing that the connecting pipes 80 are formed as being bent once, but the present invention is not limited thereto, and it is preferable that there be no bent portions in order to minimize pressure-drop of the refrigerant. That is, one end portion of each of the connecting pipes 80 may be coupled to the side surface of the first valve module 10, the connecting pipes 80 may extend linearly, and the other end portion thereof may be directly connected to the inlet pipe 160 and the outlet pipe 164. Meanwhile, connecting pipe flanges 82 for coupling with the inlet pipe flange 162 and the outlet pipe flange 166 may be provided on end portions of the connecting pipe 80.

Referring to FIG. 8, the refrigerant expanded in the second expansion valve 32 may flow out through the connecting pipe 80 and may flow into the indoor heat exchanger 144 through the inlet pipe 160 to exchange heat. In addition, the refrigerant flowing out of the indoor heat exchanger 144 after performing heat exchanging may flow into the first valve module 10 through the outlet pipe 164 and the connecting pipe 80.

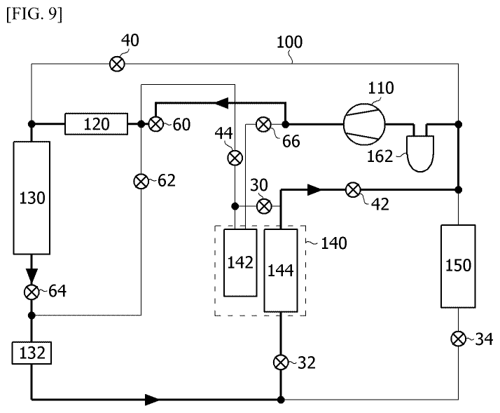

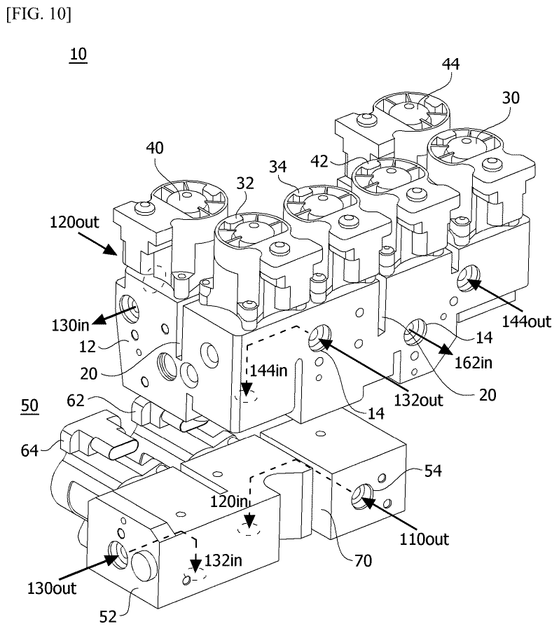

FIG. 9 is a view illustrating is a flow of the refrigerant in the cooling mode in the vehicle heat pump system according to one embodiment of the present invention, and FIG. 10 is a perspective view schematically illustrating a flow of the refrigerant in the cooling mode in the valve assembly according to one embodiment of the present invention.

Meanwhile, in FIG. 9, a seventh opening and closing valve 66 is disposed on a line along which the refrigerant is discharged from the compressor 110 and flows into the indoor condenser 142. The seventh opening and closing valve 66 may be disposed in a separate structure that is not the first valve module 10 and the second valve module 50.

In FIG. 10, “120out” indicates a line along which the refrigerant is discharged from the water-cooled condenser 120, and “130in” indicates a line along which the refrigerant flows into the outdoor heat exchanger 130. These are equally applied to other descriptions.

Referring to FIG. 9, in the cooling mode, the high-temperature and high-pressure gas phase refrigerant discharged from the compressor 110 after compressed therein flows into the water-cooled condenser 120 through the first opening and closing valve 40. The refrigerant is heat-exchanged with electric component heat at a cooling water line in the water-cooled condenser 120, flows into the outdoor heat exchanger 130, and is condensed by being heat-exchanged with external air, so that the gas phase refrigerant is changed to the liquid phase refrigerant.

After the refrigerant flowing out of the outdoor heat exchanger 130 is heat-exchanged in the inner heat exchanger 132, the refrigerant expands under reduced pressure while passing through the second expansion valve 32, becomes the low-temperature and low-pressure liquid phase refrigerant, and flows into the indoor heat exchanger 144. In this case, the indoor heat exchanger 144 operates as an evaporator.

The refrigerant flowing into the indoor heat exchanger 144 is evaporated by being heat-exchanged with air blown into the air conditioning case 140 by a blower and cools the air due to a heat absorption action of evaporative latent heat of the refrigerant at the same time, so that the cooled air is supplied to cool an interior of the vehicle. Then, the refrigerant discharged from the indoor heat exchanger 144 flows into the compressor 110 through an accumulator 112 and repeats the above-described cycle.

Referring to FIG. 10, in the cooling mode, the low-pressure refrigerant mainly flows in the first valve module 10, and the high-pressure refrigerant mainly flows in the second valve module 50. However, since the first valve module 10 and the second valve module 50 are separately provided, thermal interference can be minimized while the refrigerant flows.

In the first valve module 10, the high-pressure and middle temperature refrigerant flows in a section in which the refrigerant is discharged from the water-cooled condenser 120 and flows into the outdoor heat exchanger 130, and since a length of a flow path in the section is very small, and the section is disposed away from a low-temperature portion, effect of thermal interference is very small.

In the first valve module 10, since a flow path is formed such that the refrigerant expands in the second expansion valve 32 and is immediately discharged from the first valve module 10 in a section in which the refrigerant is discharged from the inner heat exchanger 132 and flows into the indoor heat exchanger 144 through the second expansion valve 32, there is no effect of thermal interference.

In the first valve module 10, the low-temperature and low-pressure refrigerant flows in a section in which the refrigerant is discharged from the indoor heat exchanger 144 and flows into the accumulator 112 through the second opening and closing valve 42, the adjacent high-pressure refrigerant is the refrigerant before expansion, and since a temperature of the refrigerant is relatively low, and the first recessed portion 20 is formed therebetween, effect of thermal interference is small.

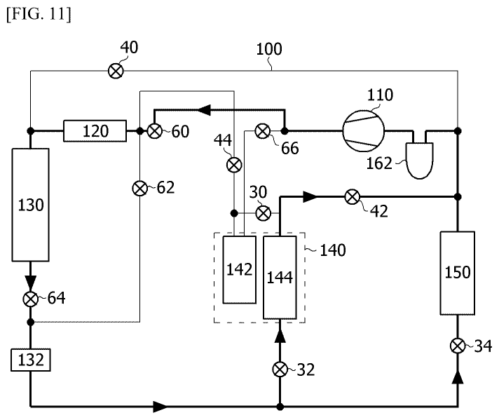

FIG. 11 is a view illustrating a flow of the refrigerant in the cooling mode when cooling a battery in the vehicle heat pump system according to one embodiment of the present invention.

Referring to the drawing, in the vehicle heat pump system, the refrigerant may flow into the chiller 150 for cooling the battery in the cooling mode. The chiller 150 serves to heat-exchange electric component heat of the battery of the vehicle with the refrigerant.

In this case, in the first valve module 10, since a flow path is provided such that the refrigerant flowing into the third expansion valve 34 expands and is immediately discharged from the first valve module 10, there is not effect of thermal interference.

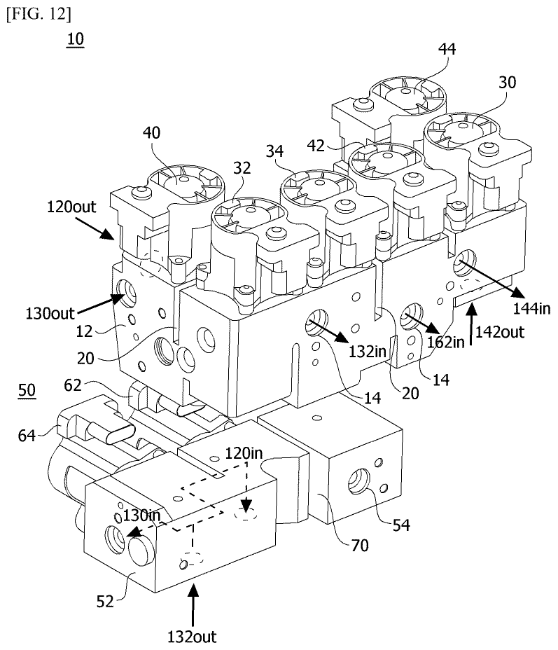

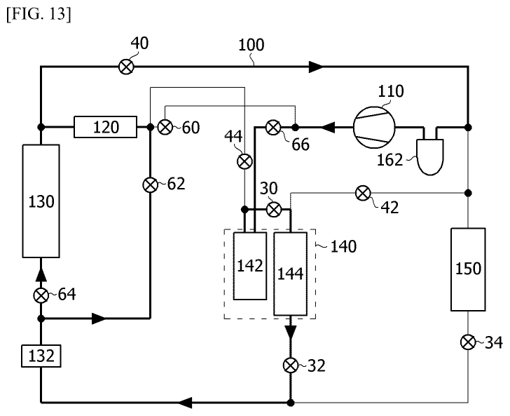

FIG. 12 is a view illustrating a flow of the refrigerant in a heating mode in the vehicle heat pump system according to one embodiment of the present invention, and FIG. 13 is a perspective view schematically illustrating a flow of the refrigerant in the heating mode in the valve assembly according to one embodiment of the present invention.

Referring to FIG. 12, in the vehicle heat pump system, when the heating mode is performed, the refrigerant discharged from the compressor 110 is heat-exchanged while passing through the indoor condenser 142, and the refrigerant may expand under reduced pressure while passing through the first expansion valve 30 before flowing into the indoor heat exchanger 144. Air heat-exchanged with the refrigerant in the indoor heat exchanger 144 is changed to warm air, and the warm air is supplied to heat the interior of the vehicle. In this case, the indoor heat exchanger 144 operates as a condenser.

The refrigerant flowing out of the indoor heat exchanger 144 may be branched off and may flow into the water-cooled condenser 120 and the outdoor heat exchanger 130 through the second expansion valve 32 and the inner heat exchanger 132. In this case, the refrigerant expands under reduced pressure in the second expansion valve 32 and passes through the inner heat exchanger 132 without additional heat exchanging.

The refrigerants heat-exchanged in the water-cooled condenser 120 and the outdoor heat exchanger 130 rejoin and flow into the accumulator 112. In this case, the water-cooled condenser 120 and the outdoor heat exchanger 130 operate as evaporators, and heat exchanging (heat absorption) may be performed in only any one of the water-cooled condenser 120 or the outdoor heat exchanger 130.

Referring to FIG. 13, in the heating mode, the low-pressure refrigerant mainly flows in both the first valve module 10 and the second valve module 50, there is little effect of thermal interference.

In the first valve module 10, since a length of a flow path in a section in which the refrigerant is discharged from the indoor condenser 142 and flows into the indoor heat exchanger 144 is very small, and the first recessed portion 20 is formed, effect of thermal interference is small.

In the first valve module 10, since a flow path is provided such that the refrigerant expands in the second expansion valve 32 and is immediately discharged from the first valve module 10 in a section in which the refrigerant is discharged from the indoor heat exchanger 144 and flows into the inner heat exchanger 132, there is no effect of thermal interference.

In the first valve module 10, although the low-temperature and low-pressure refrigerant flows around a section, in which the refrigerant is discharged from the water-cooled condenser 120 and the outdoor heat exchanger 130 and flows into the accumulator 112, before expanding, a length of a corresponding flow path is very small. In addition, since main heat exchanging of the high-pressure and low-pressure refrigerant is already completed before the section, effect of thermal interference is small.

In the second valve module 50, the low-temperature and low-pressure refrigerant flows in a section in which the refrigerant is discharged from the inner heat exchanger 132 and flows into the water-cooled condenser 120 and the outdoor heat exchanger 130. In this case, the high-temperature and high-pressure refrigerant may be partially accumulated in the fourth opening and closing valve 60, but does not flow, and thus there is small effect of thermal interference, and a second recessed portion 70 is formed to minimize the thermal interference.

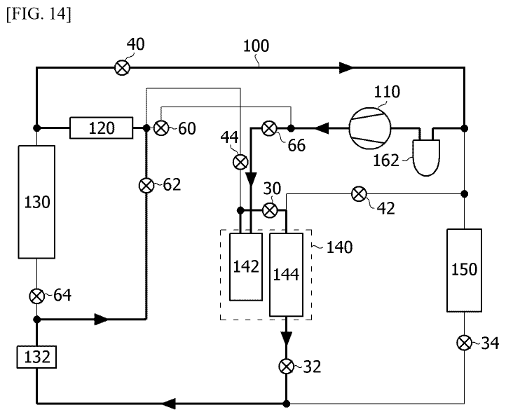

FIG. 14 is a view illustrating a flow of the refrigerant in a defrosting mode in the vehicle heat pump system according to one embodiment of the present invention.

Referring to the drawing, in the defrosting mode of the vehicle heat pump system, a refrigerant cycle substantially similar to that of the heating mode is generated. However, when it is determined that the outdoor heat exchanger 130 is covered with frost, the sixth opening and closing valve 64 disposed in a flow path connected to the outdoor heat exchanger 130 from the inner heat exchanger 132 is closed.

Accordingly, the refrigerant bypasses the outdoor heat exchanger 130 to defrost the outdoor heat exchanger 130, and the refrigerant circulates the refrigerant circulation line 100.

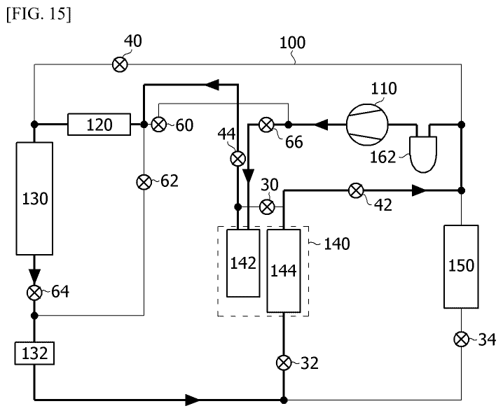

FIG. 15 is a view illustrating a flow of the refrigerant in a dehumidification/constant-temperature mode in the vehicle heat pump system according to one embodiment of the present invention.

Referring to the drawing, in the dehumidification/constant-temperature mode of the vehicle heat pump system, a refrigerant cycle substantially similar to that of the cooling mode is generated. However, the refrigerant discharged from the compressor 110 flows into the indoor condenser 142 without flowing into the outdoor heat exchanger 130 and is heat-exchanged therein, then flows into the water-cooled condenser 120, and is heat-exchanged with a cooling water line.

In the first valve module 10, the first recessed portions 20 are formed in a section, in which the refrigerant is discharged from the indoor heat exchanger 144 and flows into the accumulator 112 and a section in which the refrigerant is discharged from the indoor condenser 142, to minimize effect of thermal interference. In addition, the refrigerant is in a state in which heat is completely exchanged in the indoor heat exchanger 144, and the performance thereof may be improved when heat is partially absorbed.

According to one embodiment of the present invention, thermal interference between refrigerants flowing in the first valve module and the second valve module can be minimized by separately forming a first valve module in which a low-pressure refrigerant flows and a second valve module in which a high-pressure refrigerant flows.

In addition, according to one embodiment of the present invention, since a refrigerant flowing into a first valve housing is expanded in an expansion valve and then immediately discharged from the first valve housing, thermal interference between refrigerants can be minimized.

In addition, according to one embodiment of the present invention, a refrigerant path along which a refrigerant expanded by a second expansion valve flows into an indoor heat exchanger can be maximally minimized by directly or closely connecting the second expansion valve and the indoor heat exchanger, thereby minimizing thermal loss and pressure-drop.

While the present invention has been described above with reference to specific embodiments of the present invention, it may be understood by those skilled in the art that various modifications and changes of the present invention may be made within a range not departing from the spirit and scope of the present invention defined by the appended claims.

What is claimed is:

1. A valve assembly disposed on a line of a vehicle heat pump system in which a refrigerant flows, the valve assembly comprising:
a first valve module including a first valve housing in which a low-pressure refrigerant flows in a cooling mode and a plurality of expansion valves for expanding the refrigerant according to an air conditioning mode are disposed; and
a second valve module including a second valve housing in which a high-pressure refrigerant flows in the cooling mode and a plurality of opening and closing valves which control a flow of the refrigerant are disposed.

2. The valve assembly of claim 1, wherein the refrigerant expanded in the expansion valves is discharged to an outside through the first valve housing.

3. The valve assembly of claim 2, wherein a first recessed portion is formed in the first valve housing at a corresponding location between the expansion valve and the opening and closing valve.

4. The valve assembly of claim 3, wherein a second recessed portion is formed in the second valve housing at a corresponding location between the opening and closing valves.

5. The valve assembly of claim 4, wherein the first recessed portions and the second recessed portions are formed to have groove shapes in the first valve housing and the second valve housing.

6. The valve assembly of claim 1, wherein the expansion valves include:
a first expansion valve which expands a refrigerant discharged from an indoor condenser in a heating mode;
a second expansion valve which expands a refrigerant flowing into an indoor heat exchanger; and
a third expansion valve which expands a refrigerant flowing into a chiller.

7. The valve assembly of claim 1, wherein the opening and closing valves disposed in the first valve housing include:
a first opening and closing valve which is disposed between an outdoor heat exchanger and a compressor and controls a flow of a refrigerant;
a second opening and closing valve which is disposed between an indoor heat exchanger and the compressor and controls a flow of a refrigerant; and
a third opening and closing valve which is disposed between an indoor condenser and a water-cooled condenser and controls a flow of a refrigerant.

8. The valve assembly of claim 1, wherein the opening and closing valves disposed in the second valve housing include:
a fourth opening and closing valve which is disposed between a compressor and a water-cooled condenser and controls a flow of a refrigerant;
a fifth opening and closing valve which is disposed between an indoor heat exchanger and the water-cooled condenser and controls a flow of a refrigerant; and
a sixth opening and closing valve which is disposed between an outdoor heat exchanger and the indoor heat exchanger and controls a flow of a refrigerant.

9. A vehicle heat pump system comprising a refrigerant circulation line which circulates a compressor, a water-cooled condenser, an outdoor heat exchanger, and an indoor heat exchanger and exchanges heat between a refrigerant circulating the indoor heat exchanger and air discharged to indoors,
wherein a plurality of expansion valves which expand the refrigerant according to an air conditioning mode and a plurality of opening and closing valves which control a flow of the refrigerant are disposed on the refrigerant circulation line, and
the expansion valves are disposed in a first valve module in which a low-pressure refrigerant flows in a cooling mode.

10. The vehicle heat pump system of claim 9, wherein:
the first valve module includes a first valve housing coupled to the expansion valves; and
the vehicle heat pump system comprises a second valve module including a second valve housing in which a high-pressure refrigerant flows in the cooling mode and a plurality of opening and closing valves for controlling a flow of the refrigerant are disposed.

11. The vehicle heat pump system of claim 10, wherein:
the refrigerant expanded in the expansion valves is discharged t to an outside through the first valve housing; and
the plurality of opening and closing valves which control the flow of the refrigerant are disposed in the first valve housing.

12. The vehicle heat pump system of claim 11, wherein:
a first recessed portion is formed in the first valve housing at a corresponding location between the expansion valve and the opening and closing valve; and
a second recessed portion is formed in the second valve housing at a corresponding location between the opening and closing valves.

13. The vehicle heat pump system of claim 11, wherein:
the opening and closing valves disposed in the first valve housing include a first opening and closing valve which is disposed between the outdoor heat exchanger and the compressor and controls a flow of a refrigerant, a second opening and closing valve which is disposed between the indoor heat exchanger and the compressor and controls a flow of a refrigerant, and a third opening and closing valve which is disposed between an indoor condenser and the water-cooled condenser and controls a flow of a refrigerant; and
the opening and closing valves disposed in the second valve housing include a fourth opening and closing valve which is disposed between the compressor and the water-cooled condenser and controls a flow of a refrigerant, a fifth opening and closing valve which is disposed between the indoor heat exchanger and the water-cooled condenser and controls a flow of a refrigerant, and a sixth opening and closing valve which is disposed between the outdoor heat exchanger and the indoor heat exchanger and controls a flow of a refrigerant.

14. A vehicle heat pump system comprising a refrigerant circulation line which circulates a compressor and a plurality of heat exchangers including an indoor heat exchanger disposed in an air conditioning case and exchanges heat between a refrigerant circulating the indoor heat exchanger and air discharged to indoors,
A vehicle heat pump system comprising a compressor, a plurality of heat exchangers, an indoor heat exchanger disposed within an air conditioning case among the plurality of heat exchangers, and a refrigerant circulation line through which refrigerant circulating through the indoor heat exchanger exchanges heat with air discharged into the interior,
wherein a valve assembly including a plurality of expansion valves which expand the refrigerant according to an air conditioning mode and a plurality of opening and closing valves which control a flow of the refrigerant are disposed on the refrigerant circulation line,
the valve assembly includes a second expansion valve which expands the refrigerant flowing into the indoor heat exchanger, and
the valve assembly is connected to an inlet pipe and an outlet pipe of the indoor heat exchanger.

15. The vehicle heat pump system of claim 14, wherein the valve assembly is divided into a flow path of the refrigerant flowing into the inlet pipe and a flow path of the refrigerant flowing from the outlet pipe.

16. The vehicle heat pump system of claim 14, wherein the inlet pipe and the outlet pipe are directly connected to a side surface of the valve assembly.

17. The vehicle heat pump system of claim 14, wherein:
an inlet pipe flange and an outlet pipe flange are provided on an end portion of the inlet pipe and an end portion of the outlet pipe; and
the inlet pipe flange and the outlet pipe flange are directly connected to a side surface of the valve assembly.

18. The vehicle heat pump system of claim 14, wherein:
connecting pipes through which the refrigerant expanded in the second expansion valve is discharged are connected to a side surface of the valve assembly; and
the connecting pipes are connected to the inlet pipe and the outlet pipe.

19. The vehicle heat pump system of claim 18, wherein:
one end portion of each of the connecting pipes is coupled to the side surface of the valve assembly;
the connecting pipes expand linearly; and
the other end portion of each of the connecting pipes is coupled to the inlet pipe and the outlet pipe.

20. The vehicle heat pump system of claim 14, wherein:
the inlet pipe and the outlet pipe pass through the air conditioning case and are connected to an external part; and
the valve assembly is disposed to face one side surface of the air conditioning case through which the inlet pipe and the outlet pipe pass to an outside.
